(19) United States
(12) Patent Application Publication
(10) Pub. No.: US 2014/0075574 A1
(43) Pub. Date: Mar. 13, 2014

(54) API MONITORING METHOD AND DEVICE THEREFOR

(71) Applicant: Tencent Technology (Shenzhen) Company Limited, Shenzhen (CN)

(72) Inventors: Xing ZHENG, Shenzhen (CN); Jiahui Liang, Shenzhen (CN); Wenliang Tang, Shenzhen (CN); Danhua Li, Shenzhen (CN)

(73) Assignee: Tencent Technology (Shenzhen) Company Limited, Shenzhen (CN)

(21) Appl. No.: 14/079,584

(22) Filed: Nov. 13, 2013

Related U.S. Application Data
(63) Continuation of application No. PCT/CN2013/081448, filed on Aug. 14, 2013.

(30) Foreign Application Priority Data
Aug. 15, 2012 (CN) 201210290349.4

(51) Int. Cl. G06F 21/31

(52) U.S. Cl. CPC G06F 21/31
USPC 726/28

(57) ABSTRACT

Embodiments of the present invention provide an API monitoring method and device. The API monitoring method includes steps such as identifying a plurality of APIs as privacy-sensitive APIs; in response to detecting an invocation of one of the privacy-sensitive API by an application, determining whether the invoked API and the application satisfy a predefined condition; and if the invoked API and the application satisfy the predefined condition, suspending the invocation of the API by the application, displaying a message, wherein the message indicates that the application attempts to invoke the privacy-sensitive API; and determining whether or not to resume the invocation of the API based on a user response to the message. The device may be used to carry out the method.

### RELATED APPLICATIONS

This application is a continuation application of PCT Patent Application No. PCT/CN2013/081448, entitled “API MONITORING METHOD AND DEVICE THEREFOR” filed on Aug. 14, 2013, which claims priority to Chinese Patent Application No. 201210290349.4, entitled “API MONITORING METHOD AND DEVICE THEREFOR”, filed on Aug. 15, 2012, both of which are incorporated by reference in their entirety.

### TECHNICAL FIELD

The present invention relates to the technical field of computing device and information security, and particularly, to an API monitoring method and device.

### BACKGROUND

With the development of smart mobile terminals such as mobile phones, etc., a great number of applications are developed for such terminals, and the operating systems of the smart mobile terminals usually provide various APIs that may be used by the applications. The APIs (application programming interfaces) usually specify how some software components should interact with each other. In practice, most often an API is a library that includes specifications for routines, data structures, object classes, and variables. In other words, APIs are used by the applications to provide access to certain information items and achieve certain functions. APIs allow developing applications without accessing source codes or understanding details of the internal working mechanism. Applications on a smart mobile terminal may realize some specific functions by invoking APIs, such as reading the address book, reading the geographical location information, reading and writing short messages, accessing a network, modifying system files, etc.

However, some illegal or malicious applications may abuse the APIs to perform some illegal operations, such as secretly accessing contact information and uploading same, reading geographical location information about a user, intercepting a call of a user or silently uninstalling a program of a user, etc. Such activities may cause serious security problems to the smart mobile terminal and the user of the terminal.

Conventional API monitoring methods usually provide a list of access to APIs for a certain application when installing the application. The list is usually provided with very technical language. However, these listed access and technical language can hardly be understood by an ordinary user, and are usually ignored by the user, who routinely approves all future API invocations without carefully considering the risks involved. When some illegal or malicious applications run in a smart mobile terminal and have access to some privacy sensitive APIs, such applications bring potential security hazards to the smart mobile terminal and the user's private information.

### SUMMARY OF THE INVENTION

Accordingly, it is necessary to provide an API monitoring method which is capable of improving security for smart mobile terminals.

The current invention provides an API monitoring method for APIs in a computing device, comprising the steps of:

at the computing device having one or more processors and memory for storing one or more programs to be executed by the one or more processors,

identifying a plurality of APIs as privacy-sensitive APIs based on functions of the APIs and information items accessible to the APIs, wherein there is a prior user authorization for using the privacy-sensitive APIs by applications running on the computing device;

in response to detecting an invocation of one of the privacy-sensitive API by an application, determining whether the invoked API and the application satisfy a predefined condition:

if the invoked API and the application satisfy the predefined condition:
suspending the invocation of the API by the application;
displaying a message on a display of the computing device, wherein the message indicating that the application attempts to invoke the privacy-sensitive API; and
determining whether or not to resume the invocation of the API based on a user response to the message.

In addition, it is also necessary to provide an API monitoring device which is capable of improving security. The current invention provides an API monitoring device, comprising one or more processors, memory, and one or more program modules stored in the memory and to be executed by the one or more processors, the one or more program modules further including:

an identification module for identifying a plurality of APIs as privacy-sensitive APIs based on functions of the APIs and information items accessible to the APIs, wherein there is a prior user authorization for using the privacy-sensitive APIs by applications running on the computing device;

a determination module for determining whether the invoked API and the application satisfy a predefined condition in response to detecting an invocation of one of the privacy-sensitive API by an application; and

and a processing module for:
suspending the invocation of the API by the application;
displaying a message on a display of the computing device, wherein the message indicating that the application attempts to invoke the privacy-sensitive API; and
determining whether or not to resume the invocation of the API based on a user response to the message, if the invoked API and the application satisfy the predefined condition, or
determining whether or not to allow the invocation of the API based on a reconfirmation or overruling of the prior authorization if the invoked API and the application do not satisfy the predefined condition.

Compared to the existing technology, the current API monitoring method and device monitors and controls invocation of APIs by applications on the computing device, especially the invocation of privacy sensitive APIs by applications that already have a prior user authorization which is given when the application is installed. The current API monitoring method and device effectively improve security of the user privacy and the computing devices such as smart mobile terminals.

### BRIEF DESCRIPTION OF THE DRAWINGS

The aforementioned implementation of the invention as well as additional implementations will be more clearly understood as a result of the following detailed description of the various aspects of the invention when taken in conjunction with the drawings.

FIG. 1A is a flowchart of an API monitoring method according to one embodiment;

FIG. 1B is a flowchart of some additional steps of the API monitoring method according to another embodiment;

FIG. 2 is a flow chart of an API monitoring method according to another embodiment;

FIG. 3 is an exemplary screen shot illustrating the display of application categories based on privacy-sensitive APIs;

FIG. 4 is an exemplary screen shot illustrating the display of a sample API that may be accessed by multiple applications;

FIG. 5 is an exemplary screen shot illustrating the display of privacy-sensitive APIs based on applications;

FIG. 6 is an exemplary screen shot illustrating the display of a sample application that may access multiple privacy sensitive APIs;

FIG. 7 is an exemplary screen shot illustrating a warning message when an application is invoking a privacy-sensitive API;

FIG. 8 is a structural schematic diagram of an API monitoring device in one embodiment;

FIG. 9 is a structural schematic diagram of an API monitoring device in another embodiment; and

FIG. 10 is a block diagram illustrating different components of an API monitoring device in accordance with some implementations;

### DETAILED DESCRIPTIONS

In order to make the objectives, technical solutions, and advantages of the present invention more comprehensible, the present invention is further described below in detail with reference to the accompanying drawings.

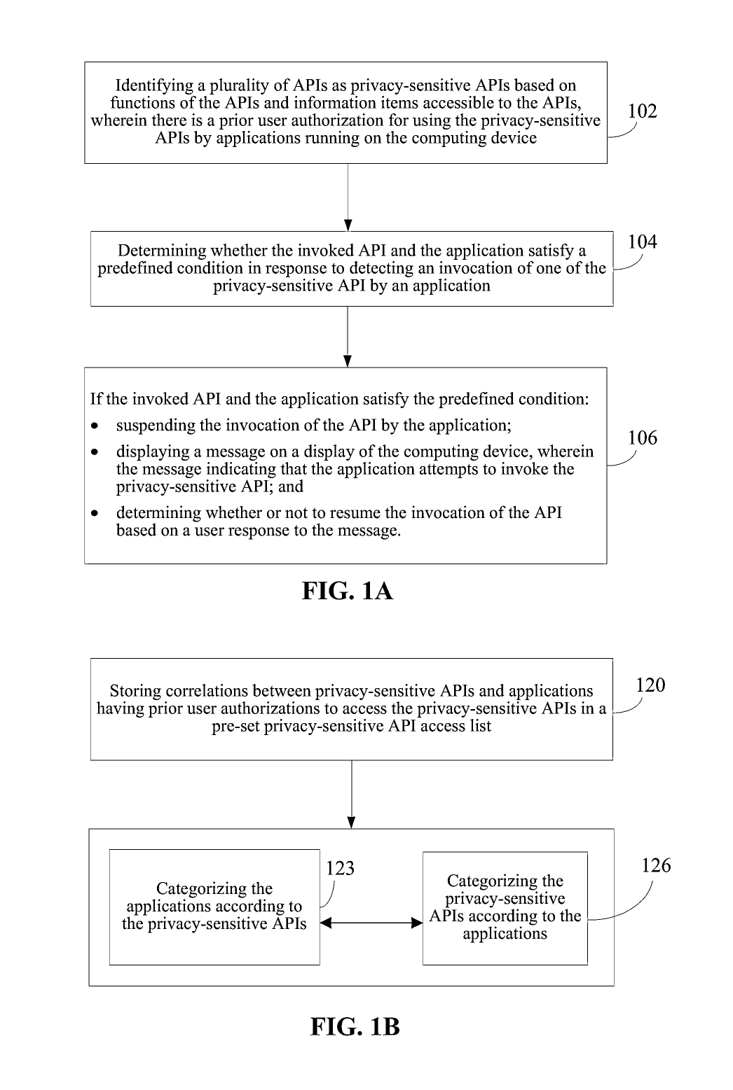

As shown in FIG. 1A, in one embodiment, an API monitoring method may comprise the following steps.

Step 102, identifying a plurality of APIs as privacy-sensitive APIs based on functions of the APIs and information items accessible to the APIs, wherein there is a prior user authorization for using the privacy-sensitive APIs by applications running on the computing device.

APIs, in general, are used to access information items and conduct certain functions. For example, some APIs may be used to search and display the short messages stored in a computing device; some APIs may be used to revise system setup; some APIs may be used to manage photos stored on the computing device; etc. The current method examines all or some of the APIs in a computing device and identifies privacy-sensitive APIs that may be accessed by applications. The privacy-sensitive APIs are identified by the information items that may be accessed by the APIs and the functions the APIs may perform. For example, APIs that may access private information items such as but not limited to personal pictures, messages, phone records, current locations, and chatting histories may be identified as privacy-sensitive APIs. In addition, for example, APIs that may access networking information, system information of the computing device may also be identified as privacy-sensitive APIs. APIs that may delete or block access to certain information items may also be identified as privacy-sensitive APIs.

It should be noted that the privacy-sensitive APIs may cover any of APIs that deal with information items and functions that may be deemed important to the protection of user privacy and system security, and are not necessarily limited to the narrow meaning of personal information. The identification criteria may be preset by the operating system, by the user, or by the programs that carries out the current method. The identification criteria may also be altered if the user feels the need to do so.

In some cases, when an application is installed on a computing device, or when the application is run for the first time, the user is provided the chance to authorize the access to certain APIs, such as the privacy-sensitive APIs, by the application. In some other cases, installing the application itself provides such an authorization. Such prior authorizations are unlikely to be provided with careful consideration of the risks that may be involved. Some implementations of the current invention provide additional chances to allow the user to limit the invocation of privacy-sensitive APIs by the applications that already have a prior authorization.

Step 104, determining whether the invoked API and the application satisfy a predefined condition in response to detecting an invocation of one of the privacy-sensitive API by an application.

When an application is running, various APIs may be invoked for realizing corresponding functions, and if an invoked API is not a privacy-sensitive API, as identified in Step 102, then the current method does not intervene. Whether such an invocation will result in another authorization process may be determined by other factors such as the installation setup. However, when the API that is invoked is a privacy-sensitive API, then it should be determined when the invoked privacy-sensitive API satisfy a predefined condition and whether the invocation should be completed.

The predefined condition may be generated by the program carrying out the current method or entered by the user, or a combination of both. The predefined condition may be any kinds of conditions that may be logically determined whether it is satisfied or not. For example, the predefined condition may be specifically requiring reconfirmation of the prior user authorization of allowing the application to invoke the privacy-sensitive API. In some implementations, the predefined condition may be a condition that is automatically and invariably satisfied, e.g. if “the next invocation happens after year 1001,” then . . . . On the other hand, the predefined condition may be a condition that is automatically and invariably unsatisfied, e.g. if “the next invocation happens before year 1001,”, then . . . . The predefined condition may also be a condition that needs more in depth analysis and data gathering and cannot be determined before the invocation actually takes place. For example, the predefined condition may be that the time between the current invocation and the previous authorization is longer than a threshold time period, e.g. 30 days. In this case, for instance, the application is last used on Jan. 1, 2013, when the previous authorization for the application to invoke a particular privacy-sensitive API is given; the privacy-sensitive API is then invoked by the application on Feb. 15, 2013; then the predefined condition is satisfied and re-determination of further invocation is required. Alternatively, the predefined condition may involve a randomized event, e.g. if “the next invocation happens at a year larger than a number randomly generated between 1000 and 3000,” then . . . . The specific approach to set the predefined condition may vary. The predefined condition may also be altered before and/or after a determination of invocation is reached. Some approaches to set and/or alter the predefined condition are discussed below.

Step 106: If the invoked API and the application satisfy the predefined condition: suspending the invocation of the API by the application; displaying a message on a display of the computing device, wherein the message indicates that the application attempts to invoke the privacy-sensitive API; and determining whether or not to resume the invocation of the API based on a user response to the message.

Step 106 may be viewed as a bifurcated process to determine whether a specific invocation should be completed. Step 104 may be viewed as the gateway to control which branch of Step 106 is necessary.

When the invoked privacy-sensitive API and the application satisfy the predefined condition, re-determination of the invocation is required. Thus, the on-going invocation is suspended and the user is inquired by a message displayed on the computing device as to whether to proceed with the invocation. The detailed content of the message may vary but it may include the notice that the application is attempting to invoke a privacy-sensitive API. The user response to the message, or the lack of a direct response, may determine whether the invocation may be resumed completed.

FIG. 1B is a flowchart of additional steps of the API monitoring method according to another embodiment.

Step 120: Storing correlations between privacy-sensitive APIs and applications having prior user authorizations to access the privacy-sensitive APIs in a pre-set privacy-sensitive API access list.

After the privacy-sensitive APIs are identified, the applications that have prior authorization to access the privacy-sensitive APIs are also identified. The correlations between the privacy-sensitive APIs and the applications may be stored in a privacy-sensitive API access list. It should be noted that the correlation may or may not be a one-to-one association. In some cases, one application may have authorization to access multiple privacy-sensitive APIs; in some other cases, one privacy-sensitive API may be accessed by multiple applications that have authorization. The key features of the privacy-sensitive API access list are: (1) with an inquiry or multiple inquiries, the privacy-sensitive APIs associated with a particular application may be identified, and (2) with an inquiry or multiple inquiries, the applications associated with a particular privacy-sensitive API may also be identified. In essence, a mapping relationship between the applications and the privacy-sensitive APIs are established.

Step 123: Categorizing the applications according to the privacy-sensitive APIs.

Step 126: Categorizing the privacy-sensitive APIs according to the applications.

It should be noted that Steps 123 and 126 are optional steps and there is no specific requirement as to which one is performed and which one is performed first. It is possible that only one of Steps 123 and 126 is performed. When both Steps are performed, Step 123 may be before or after Step 126.

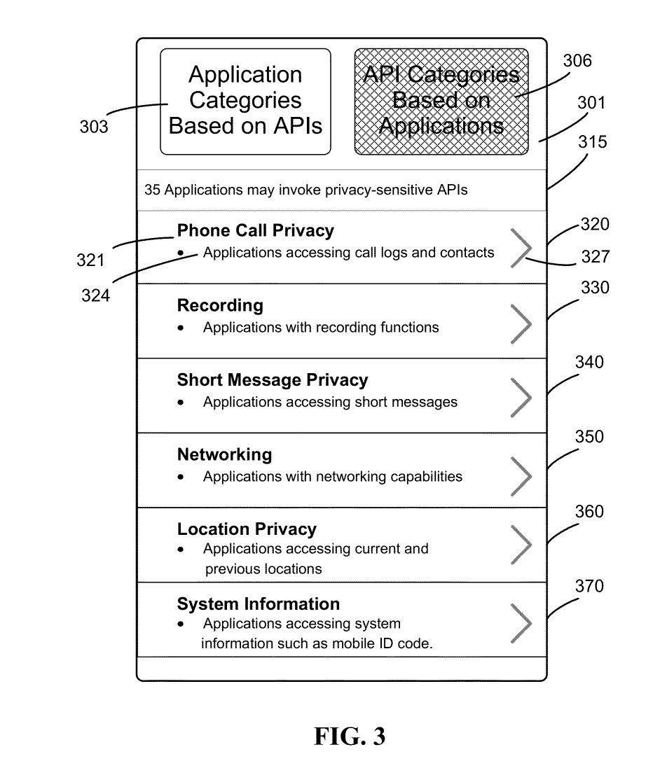

As indicated in the description for Step 120, it is possible that multiple applications are associated with a single privacy-sensitive API. Therefore, it is possible to categorize the applications according to the privacy-sensitive APIs that are associated with the applications, as indicated by Step 123. In some implementations, the categories of the applications based on privacy-sensitive APIs may be displayed. FIG. 3 below provides an example for such categorization and display.

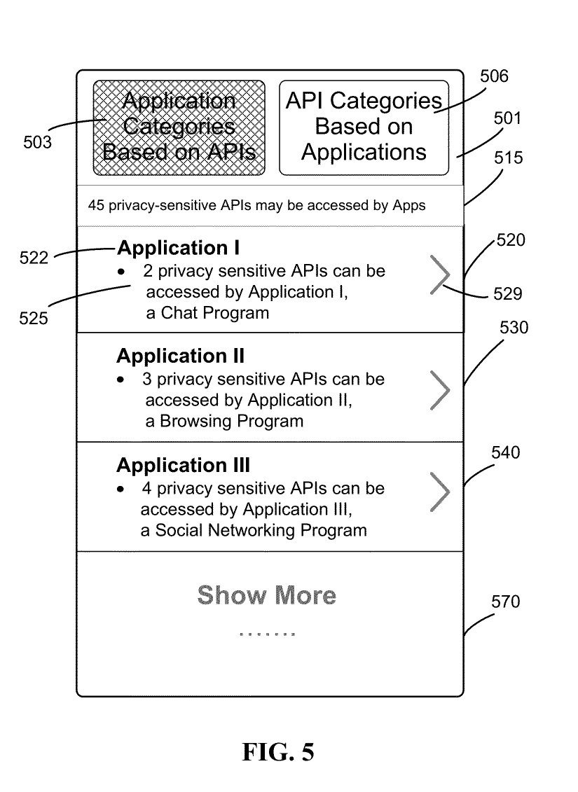

Similarly, it is possible that multiple privacy-sensitive APIs may be invoked by a single application. Therefore, it is possible to categorize the privacy-sensitive APIs according to the applications that have prior authorization to invoke the privacy-sensitive APIs, as indicated by Step 126. In some implementations, the categories of the privacy-sensitive APIs based on applications may be displayed. FIG. 5 below provides an example of such categorization and display.

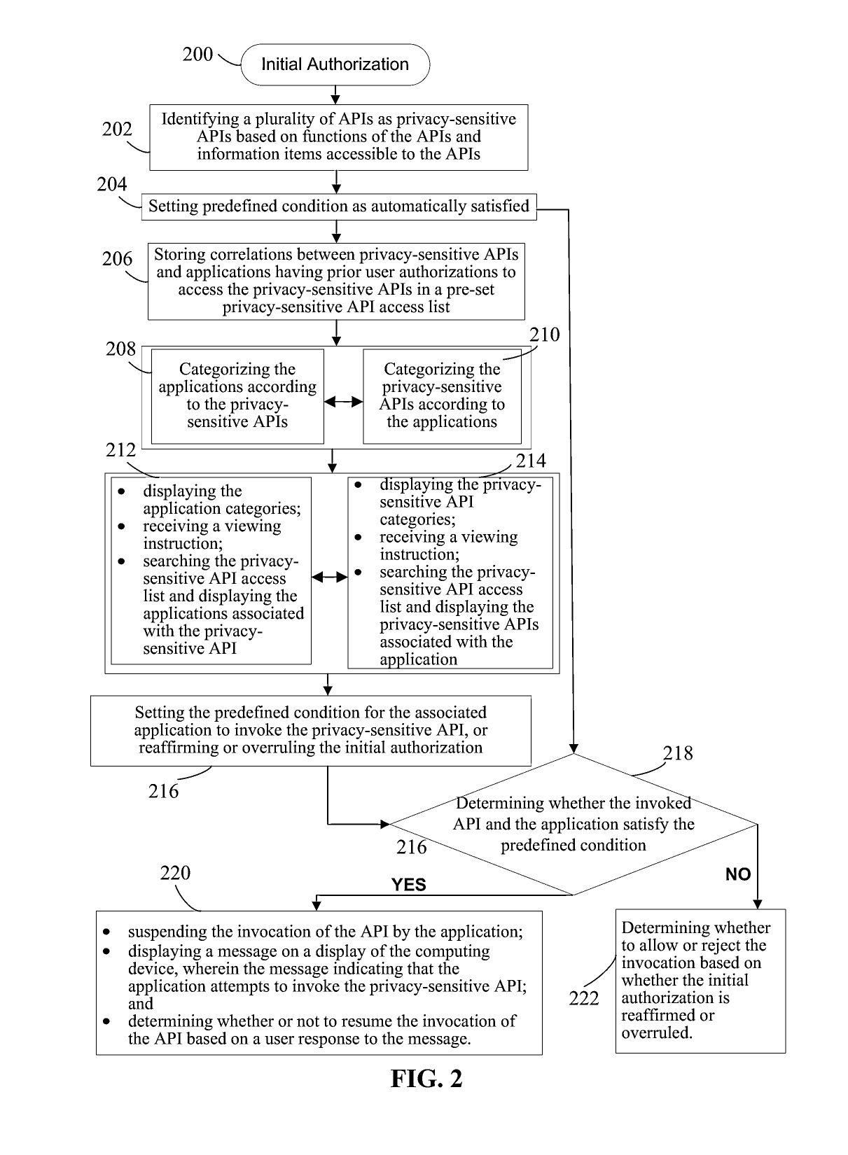

FIG. 2 is a flow chart of an API monitoring method according to another embodiment. The embodiment shown in FIG. 2 includes more optional steps and variations than what is shown in FIGS. 1A and 1B.

Step 200: prior authorization. As indicated above, for some applications the authorization to access particular privacy-sensitive APIs must be given by the user before or during installation of the applications. In some other cases, the prior authorization is provided not during installation, but through other processes, even the processes included in the current method. With the prior authorization, the application is able to access the privacy-sensitive API if the prior authorization is not overruled.

Step 202: Identifying a plurality of APIs as privacy-sensitive APIs based on functions of the APIs and information items accessible to the APIs. Step 202 is similar to Step 102, as described in FIG. 1A.

Step 204: Setting the predefined condition as automatically satisfied. This is an optional step, which ensures that the general user-determination Step 220, as described below, is performed if Step 218 takes place before the user setup Steps 212 and 214. By setting the predefined condition as automatically and invariably satisfied, the determination Step 218 always results in a positive outcome so that Step 220 is performed, giving the user a chance to determine whether a privacy-sensitive API can be accessed. As indicated above, any approach may be used to set the predefined condition to be automatically satisfied. For example, the condition can be requiring reconfirmation of the prior user authorization of allowing the application to invoke the privacy-sensitive API the condition or it can be: if “the next invocation happens after year 1001,” then . . . .

Step 204 may be necessary when it is likely that an invocation of a privacy-sensitive API takes place before the additional setup steps such as Step 214, as described below, is performed. In such cases, with Step 204, the determination of the invocation goes through Step 220 because the predefined condition is automatically satisfied. Thus, the user always gets the chance to reaffirm or overrule the prior authorization regarding the access of a privacy-sensitive API by an application. It should also be noted that Step 204 is optional.

Step 206: Storing correlations between privacy-sensitive APIs and applications having prior user authorizations to access the privacy-sensitive APIs in a pre-set privacy-sensitive API access list. Step 206 is similar to Step 120, as described in FIG. 1B.

Steps 208 and 210 are similar to Steps 123 and 126, respectively, as described for FIG. 1B. In particular, Step 208: Categorizing the applications according to the privacy-sensitive APIs; Step 210: Categorizing the privacy-sensitive APIs according to the applications.

Step 212: Displaying the application categories according to the privacy-sensitive APIs in a privacy monitoring interface; receiving a user input for viewing the applications in an application category; and searching the privacy-sensitive API access list and displaying the applications associated with the privacy-sensitive API as requested by the user input.

Step 214: Displaying the privacy-sensitive API categories according to the applications in an application monitoring interface; receiving a user input for viewing the privacy-sensitive APIs associated with an application; and searching the privacy-sensitive API access list and displaying the privacy-sensitive APIs associated with the application.

Steps 212 and 214 correspond to Steps 208 and 210, respectively. Similarly, Steps 212 and 214 are optional steps and are not mutually exclusive. It is possible to perform one or both of the Steps and it is possible to perform one before the other.

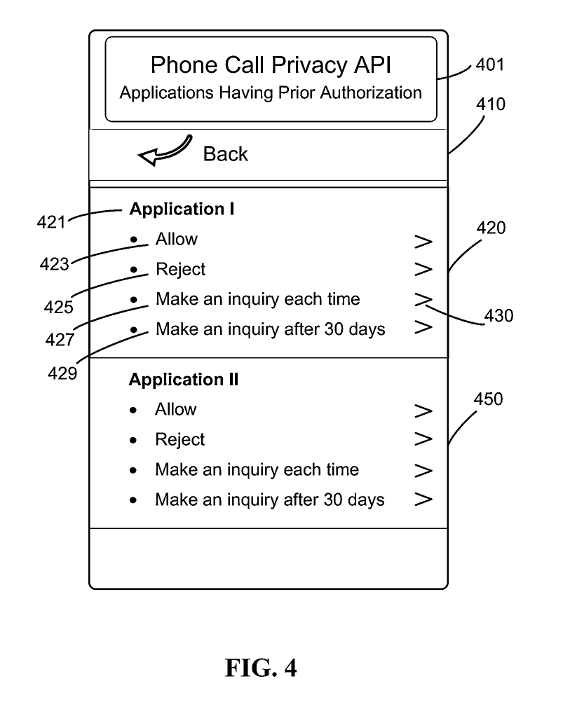

Step 212 displays the application categories and in response to the user input, the specific applications are displayed so that the user may have the chance to reset the predefined condition and/or decide whether the application may access the associated privacy-sensitive API. A more detailed and illustrated description of Step 212 is provided by FIGS. 3 and 4.

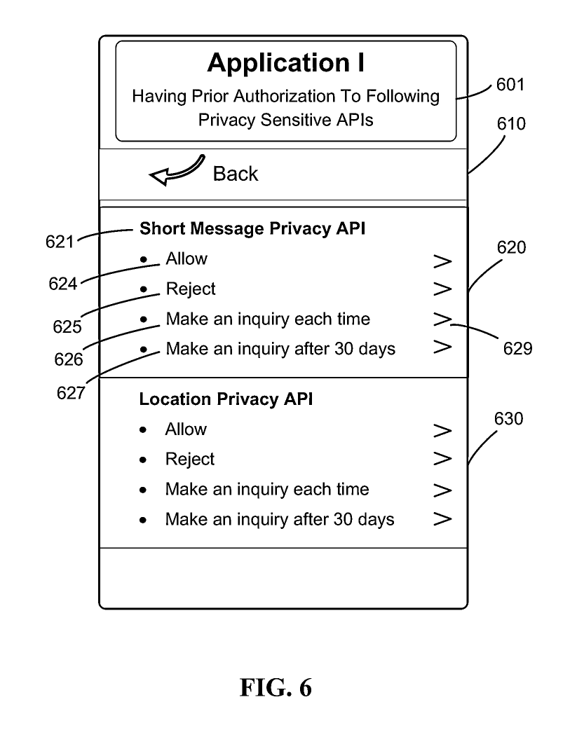

Step 214 displays the privacy-sensitive API categories and in response to the user input for viewing, the specific privacy-sensitive APIs are displayed so that the user may have the chance to reset the predefined condition and/or decide whether the application may access the associated privacy-sensitive API. A more detailed and illustrated description of Step 214 is provided by FIGS. 5 and 6.

Step 216: Setting the predefined condition for the associated application to invoke the privacy-sensitive API or reaffirming or overruling the initial authorization.

As indicated above, the predefined condition may be altered and Step 216 illustrates how it may be changed. In Step 204, the predefined condition is set to be automatically satisfied so that the final determination step of 220 may not be bypassed without user input. However, Step 216 itself involves user input, making it unnecessary to always go through the determination step 220.

The predefined condition may be set to any form. For example, the predefined condition may directly require reconfirmation of the prior user authorization of allowing the application to invoke the privacy-sensitive API. Or the condition may involve a randomization—the further determination is required only for applications/APIs that are randomly chosen. As another example, the predefined condition may be that the time between the next invocation and the initial authorization (or the last authorization) is longer than a threshold period, e.g. 30 days. In this case, whenever more than 30 days pass without user authorization, the determination step 220 needs to be performed.

It is possible that in Step 216, the predefined condition is set to be automatically satisfied. In this case, the next invocation will automatically go through the determination step 220.

It is also possible that in Step 216, the prior user authorization is directly reconfirmed or overruled. With such a setup, the determination step 220 is bypassed. Here, the user may choose to reaffirm or overrule the prior authorization. If the user reconfirms the prior authorization, the invocation of the privacy-sensitive API by the application is to be successful; if the user overrules the prior authorization, the invocation of the privacy-sensitive API by the application is to be unsuccessful. Such a determination is reflected in Step 222.

Step 218: Determining whether the invoked API and the application satisfy the predefined condition in response to detecting an invocation of one of the privacy-sensitive API by an application. Step 218 is similar to Step 104 in FIG. 1A.

With Step 218, the predefined condition is examined and the invocation may be determined by Step 220 or Step 222.

Step 220: If the invoked API and the application satisfy the predefined condition: suspending the invocation of the API by the application; displaying a message on a display of the computing device, wherein the message indicating that the application attempts to invoke the privacy-sensitive API; and determining whether or not to resume the invocation of the API based on a user response to the message. Step 220 is similar to Step 106 in FIG. 1A.

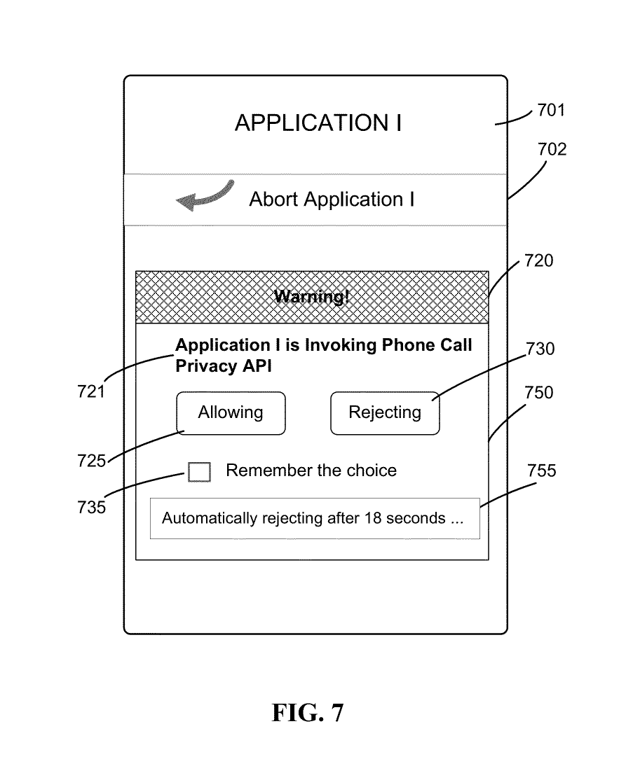

Step 220 is the determination step with the involvement of instant user inquiry. A more detailed and illustrated description of Step 220 is provided by FIG. 7.

Step 222: If the invoked API and the application do not satisfy the predefined condition: determining whether to allow or reject the invocation based on whether the initial authorization is reconfirmed or overruled.

Step 222 takes place when the result from Step 218 is negative. However, since Step 216 already involves user choices, bypassing the determination step 220 is not too problematic.

FIG. 3 is an exemplary screen shot illustrating the display of application categories based on privacy-sensitive APIs. Shown in FIG. 3 are a title panel 301, the application category panels 320, 330, 340, 350, 360, and 370, and a summary panel 315.

The title panel 301 incorporates a first categorization title 303 and a second categorization title 306, wherein only the first categorization title 303 is highlighted in FIG. 3. Here the first categorization title 303 is “Application Categories Based on APIs” and the second categorization title 306 is “API Categories Based on Application.” It should be noted that the format and details of the display may vary according to the preference of the designer and the contents of the display. For example, with the same contents, first categorization title 303 may be simplified to “App Categories” and the second categorization title 306 may be simplified to “API Categories.”

As indicated in the description for Step 123 in FIG. 1B, FIG. 3 provides an example of display for the categorization of applications based on privacy-sensitive APIs. Here the first categorization title 303 is highlighted, indicating that the display below is detailed illustration of the application categories.

The optional summary panel 315 provides a summary for the applications that have prior authorization to invoke privacy-sensitive APIs installed in the computing device. The exact wording and contents of the summary panel 315 may vary according to the setup and may be altered by the user. For example, the summary panel 315 may show the number of categories the applications may be classified into.

The application category panels 320, 330, 340, 350, 360, and 370 illustrate individual categories. It should be noted that since the categorization is based on privacy-sensitive APIs, the categories are shown according to the privacy-sensitive APIs. However, the underlying operation is that the applications are categorized.

One approach is to use individual privacy-sensitive APIs as the criteria for categorization. For example, even if privacy-sensitive API 1 and privacy-sensitive API 2 are dealing with the same information item such as a contact list (e.g. privacy-sensitive API 1 is used for searching the contact list and privacy-sensitive API 2 is used for updating the contact list), the applications associated with privacy-sensitive API 1 and privacy-sensitive API 2 are categorized into different sets. Alternatively, before the categorization of the applications, an initial categorization of the privacy-sensitive APIs may be performed. For example, all the privacy-sensitive APIs that deal with a certain function, such as recording sound or image, may be categorized into a single group. Then all the applications associated with these privacy-sensitive APIs may be categorized into a class. Either approach may be used, depending on the setup of the program and/or device carrying out the current method and the user's input.

The application category panels 320, 330, 340, 350, 360, and 370 display certain application categories. It should be noted that the display may vary according to the setup of the program and/or device carrying out the current method and the user's input. Since each of the application category panels has a similar format, to avoid redundancy, only the components of the application category panel 320 are marked, wherein the components include: a category title 321, a brief description 324, and a viewing indicator 327.

The category title 321, along with the other category titles in FIG. 3, shows the categories according to which the applications are classified. As indicated above, the category titles may cover individual privacy-sensitive APIs or a group of privacy-sensitive APIs. The detailed contents of the category titles may vary.

The brief description 324, along with the other brief descriptions in FIG. 3, provides a basic summary of the applications that are covered in the category. For example, as shown by brief description 324, the applications in this category have prior authorization to access call logs and contact lists. The specific descriptions may vary. For example, the description may include the names and/or logos of some or all of the applications in the particular category.

The viewing indicator 327, along with the other viewing indicators in FIG. 3, invites the user to click or tap on the category panel to view details of the applications in this category and set the predefined conditions for the invocation of privacy-sensitive API by the application.

For example, category panel 320 for “phone call privacy” serves to group a number of applications that have prior authorization to access this particular privacy-sensitive API (if “phone call privacy” is a privacy-sensitive API), or access a group of privacy-sensitive APIs (if “phone call privacy” is a group of privacy-sensitive APIs). By tapping or clicking the category panel 320, the user sends, and program receives a user input for viewing the applications in an application category, as indicated by Step 212 of FIG. 2. In response, the privacy-sensitive API access list is searched and the applications associated with the privacy-sensitive API (or privacy-sensitive APIs) are displayed as requested by the user input.

FIG. 4 is an exemplary screen shot illustrating the display of a sample API that may be accessed by multiple applications. FIG. 4 shows an example of what may be displayed after the user input is received, as indicated in the descriptions for FIG. 3. Shown in FIG. 4 are a title panel 401, a Back panel 410, and multiple application panels 420 and 450. FIGS. 3 and 4 provide illustrated descriptions of Steps 212 and 216 in FIG. 2.

The title panel 401 provides a title for the category—here the title panel 401 is “Phone Call Privacy API, Applications Having Prior Authorization.” In essence, the title panel, the exact content of which may vary, provides that the applications herein listed and categorized together because the applications have prior authorization to the phone call privacy API (or APIs).

The Back panel 410 provides a route to switch back to the categorization menu, as shown in FIG. 3.

The application panels 420 and 450, as shown in FIG. 4, have similar components. Therefore, only the components of application panel 420 are marked, which include an application title 421, an “Allow” choice 423, a “Reject” choice 425, a “Make an inquiry each time” choice 427, a “Make an inquiry after 30 days” choice 429, and multiple execution indicators 430.

The application title 421 provides the name or an alias of the application that have prior authorization to access the privacy-sensitive API or privacy-sensitive APIs listed in the title panel 401. A brief description of the application may also be incorporated. For example, “Application I is a chat program installed on 1/1/2013.” The exact contents may vary.

The functions of the choices 423, 425, 427 and 429 are largely self-explanatory. The execution indicators 430 indicate that these choices may be executed. A further confirmation and cancellation may be implemented for the choices. The choices 423, 425, 427 and 429 allow the user to set the predefine condition, as explained for Step 104 of FIG. 1A. The exact wording and format of the choices may vary according to the setup of the program carrying out the current method and the user's preferences.

The “Allow” choice 421 indicates that when an invocation is detected, the invocation should be allowed. The “Reject” choice 423 indicates that when an invocation is detected, the invocation should be rejected. Essentially, choosing the “Allow” choice 421 or the “Reject” choice 423 bypasses Step 220 shown in FIG. 2. A decision regarding whether the invocation is successful is rendered without further input from the user when the privacy-sensitive API is actually invoked. From another perspective, the “Allow” choice 421 reconfirms the prior authorization for Application Ito access the privacy-sensitive API; the “Reject” choice 423 overrules the prior authorization. In view of Step 216, choosing the “Allow” choice 421 or the “Reject” choice 423 may also be viewed as setting the predefined condition automatically unsatisfied so that the user does not need to make a further choice when the privacy-sensitive API is actually invoked.

The “Make an inquiry each time” choice 427 makes it mandatory that a user input is required for the next invocation. The inquiry to request user input is fully described and illustrated in FIG. 7 In a way, choice 427 may be viewed as setting the predefined condition as automatically satisfied so that the determination step 220 in FIG. 2 may not be bypassed.

The “Make an inquiry after 30 days” choice 429 sets the predefined condition to be that the time between the current setup and the next invocation is longer than 30 days. If the condition is satisfied, then an inquiry that prompts user input is made, wherein the inquiry is fully described and illustrated in FIG. 7. If the condition is not satisfied, then the prior authorization may be applicable and the privacy-sensitive API is accessed by the application.

As indicated above, the predefined condition may be set in any form. Correspondingly, the choices 423, 425, 427, and 429, may take any form. More choices may be added. The user or the program carrying out the current method may set a choice as “Make a random inquiry” or “Make an inquiry if application was installed within the last 30 days,” or “Make an inquiry if more than 30 days between invocation,” or “Make an inquiry if application occupies more than 10% system memory.” The possibilities are endless.

FIG. 5 is an exemplary screen shot illustrating the display of privacy-sensitive APIs based on applications. Shown in FIG. 5 are a title panel 501, the privacy-sensitive API category panels 520, 530, and 540, an extension panel 570, and a summary panel 515.

The title panel 501 incorporates a first categorization title 503 and a second categorization title 506, wherein only the second categorization title 506 is highlighted in FIG. 5. As indicated above, the format and details of the display may vary according to the preference of the designer and the contents of the display.

As indicated in the description for Step 126 in FIG. 1B, FIG. 5 provides an example of display for the categorization of privacy-sensitive APIs based applications. Here the second categorization title 506 is highlighted, indicating that the display below is detailed illustration of the privacy-sensitive API categories.

The optional summary panel 515 provides a summary for the privacy-sensitive APIs that may be accessed by applications installed in the computing device. The exact wording and contents of the summary panel 515 may vary according to the setup and may be altered by the user.

The privacy-sensitive API category panels 520, 530, and 540 illustrate individual categories. It should be noted that since the categorization is based on applications, the categories are shown according to the applications. However, the underlying operation is that the privacy-sensitive APIs are categorized.

One approach is to use individual applications as the criteria for categorization. Alternatively, an initial categorization of the applications may be performed before the privacy-sensitive APIs are categorized. For example, all the applications that deal with video display may be categorized into a single group. Then all the privacy-sensitive APIs associated with the group may be categorized into a class. Either approach may be used.

The privacy-sensitive API category panels 520, 530, and 540 display certain privacy-sensitive API categories. It should be noted that the display may vary according to the setup of the program and/or device carrying out the current method and the user's input. Since each of the privacy-sensitive API category panels has a similar format, to avoid redundancy, only the components of the privacy-sensitive API category panel 520 are marked, wherein the components include: a category title 522, a brief description 525, and a viewing indicator 529.

The category title 522, along with the other category titles in FIG. 5, shows the categories according to which the privacy-sensitive APIs are classified. As indicated above, the category titles may cover individual applications or a group of applications. The detailed contents of the category titles may vary.

The brief description 525, along with the other brief descriptions in FIG. 5, provides a basic summary of the privacy-sensitive APIs that are covered in the category. For example, as shown by brief description 525, two privacy-sensitive APIs in this category may be accessed by Application I, which has been granted prior authorization. The specific descriptions may vary. For example, the description may include the names and/or logos of some or all of the applications in the particular category.

The viewing indicator 529, along with the other viewing indicators in FIG. 5, invites the user to click or tap on the category panel to view details of the privacy-sensitive APIs in this category and set the predefined conditions for the invocation of privacy-sensitive APIs by the application.

For example, category panel 520 for “Application I” serves to group a number of privacy-sensitive APIs that can be accessed by Application I, which has prior authorization. By tapping or clicking the category panel 520, the user sends, and program receives a user input for viewing the privacy-sensitive APIs in a privacy-sensitive API category, as indicated by Step 214 of FIG. 2. In response, the privacy-sensitive API access list is searched and the privacy-sensitive API associated with Application I are displayed as requested by the user input.

FIG. 6 is an exemplary screen shot illustrating the display of a sample application that may access multiple privacy sensitive APIs. FIG. 6 shows an example of what may be displayed after the user input is received, as indicated in the descriptions for FIG. 5. Shown in FIG. 6 are a title panel 601, a Back panel 610, and multiple application panels 620 and 630. FIGS. 5 and 6 provide illustrated descriptions of Steps 214 and 216 in FIG. 2.

The title panel 601 provides a title for the category. In essence, the title panel 601, the exact content of which may vary, provides that the privacy-sensitive APIs herein listed and categorized together because Application I has prior authorization to access these privacy-sensitive APIs. The Back panel 410 provides a route to switch back to the categorization menu, as shown in FIG. 3.

The privacy-sensitive API panels 620 and 630, as shown in FIG. 6, have similar components. Therefore, only the components of privacy-sensitive API panel 620 are marked, which include a privacy-sensitive API title 421, an “Allow” choice 624, a “Reject” choice 625, a “Make an inquiry each time” choice 626, a “Make an inquiry after 30 days” choice 627, and multiple execution indicators 629.

The privacy-sensitive API title 621 provides the name or an alias of the privacy-sensitive API that can be accessed by Application I. A brief description of the privacy-sensitive API may also be incorporated. The exact contents may vary.

The descriptions and variations for the choices 624, 625, 626, and 627 are essentially the same as for the choices 423, 425, 427, and 429 in FIG. 4.

FIG. 7 is an exemplary screen shot illustrating a warning message when an application is invoking a privacy-sensitive API. FIG. 7 essentially corresponds to Step 220 in FIG. 2, wherein the user may make entries to allow or reject the invocation of a privacy-sensitive API by an application. Shown in FIG. 7 are a title panel 701, an Abort panel 702, and a warning panel 750.

The warning panel 750 may include a warning title 720, a short description 721, an “Allowing” button 725, a “Rejecting” button 730, a permanency option 735, and a default action display 755.

The title panel 701 describes which application is running The abort panel 702 allows the user to abort the application. The short description 721 provides notice that Application I is invoking the phone call privacy API. The exact contents of these panels and descriptions may vary.

The “Allowing” button 725 and the “Rejecting” button 730 provides the user choices to allow or reject the invocation of the privacy-sensitive API by the application. The permanency option 735 provides the user the option to make the choice of “Allowing” or “Rejecting” permanent. The exact format of 725, 730, and 735 may vary. For example, the permanency option 735 may only be “Remember the choice for 30 days” so that the allowing and rejecting herein enter may only stand for 30 days. In essence, the permanency option 735 may be considered as changing the predefined condition again.

The default action display 755, in FIG. 7, automatically rejects the invocation with a certain time limit, e.g. 30 seconds, if the user does not make any input. The display of seconds in 755 may be a countdown. The exact contents of the default action display 755 may vary. For example, the default action may be allowing, instead of rejecting, the invocation if the user does not make an entry.

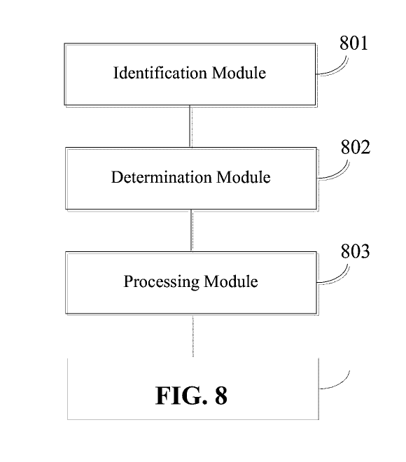

FIGS. 8-10 illustrate API monitoring devices that may be used to perform the API monitoring methods described above. To avoid redundancy, not all the details and variations described for the method are herein included for the devices. Such details and variations should be considered included for the description of the devices as long as they are not in direct contradiction to the specific description provided.

FIG. 8 shows an API monitoring device, comprising: an identification module 801, a determination module 802, and a processing module 803.

The identification module 801 may be used to identify a plurality of APIs as privacy-sensitive APIs based on functions of the APIs and information items accessible to the APIs, wherein there is a prior user authorization for using the privacy-sensitive APIs by applications running on the computing device.

The determination module 802 may be used to determine whether the invoked API and the application satisfy a predefined condition in response to detecting an invocation of one of the privacy-sensitive API by an application.

The processing module 803 may be used to suspend the invocation of the API by the application, display a message on a display of the computing device, wherein the message indicates that the application attempts to invoke the privacy-sensitive API, and determine whether or not to resume the invocation of the API based on a user response to the message, if the invoked API and the application satisfy the predefined condition.

The processing module 803 may also be used for determining whether or not to allow the invocation of the API based on a reconfirmation or overruling of the prior authorization if the invoked API and the application do not satisfy the predefined condition.

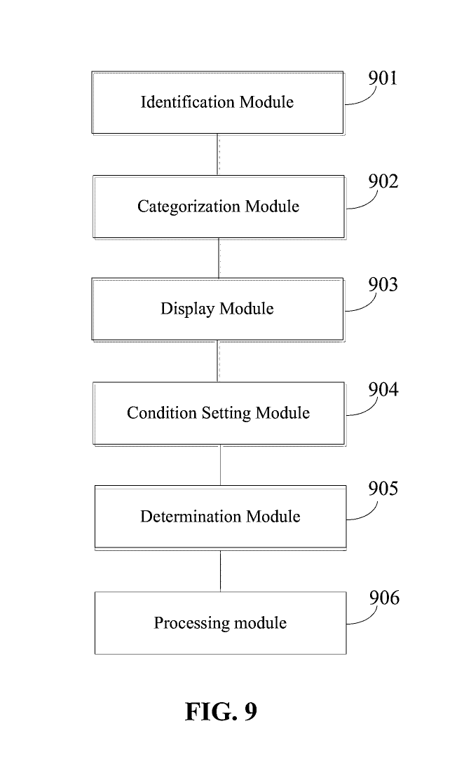

FIG. 9 shows an API monitoring device, comprising: an identification module 901, a categorization module 902, a display module 903, a condition setting module 904, a determination module 905, and a processing module 906.

The identification module 901, the determination module 905, and the processing module 906 may have the same function as the identification module 801, the determination module 802, and the processing module 803 in FIG. 8, respectively.

The categorization module 902 may be used for storing correlations between privacy-sensitive APIs and applications having prior user authorizations to access the privacy-sensitive APIs in a pre-set privacy-sensitive API access list, categorizing the applications according to the privacy-sensitive APIs, and/or categorizing the privacy-sensitive APIs according to the applications,

The display module 903 may be used for displaying the application categories according to the privacy-sensitive APIs in a privacy monitoring interface, receiving a user input for viewing the applications in an application category, and searching the privacy-sensitive API access list and displaying the applications associated with the privacy-sensitive API as requested by the user input.

The condition setting module 904 may be used for setting the predefined condition and/or confirming or overruling the prior authorization.

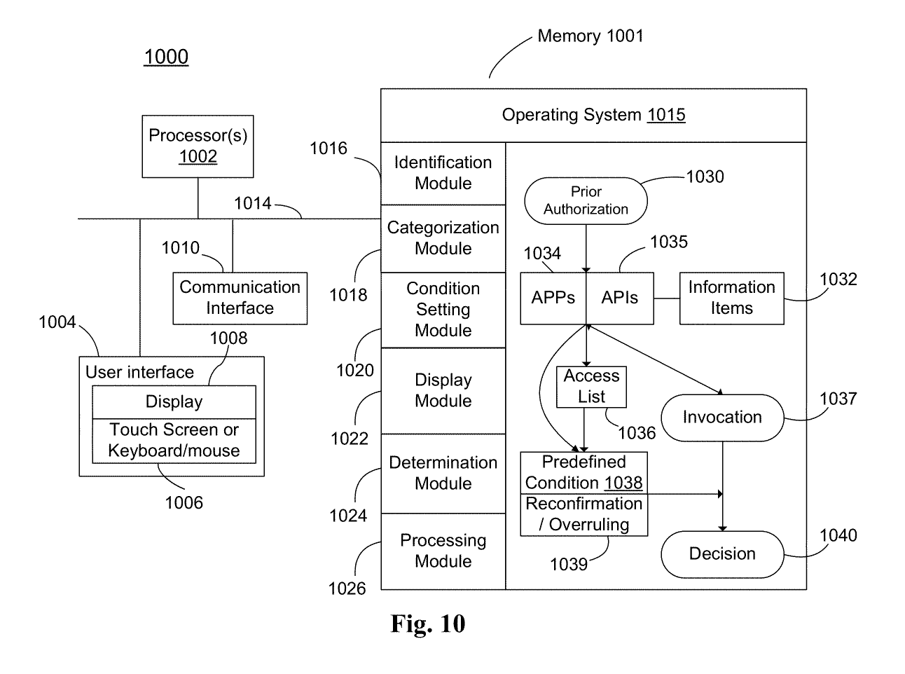

FIG. 10 is a block diagram illustrating different components of an API monitoring device 1000 (e.g. a mobile terminal or a computer) according to some embodiments of the present invention. While certain specific features are illustrated, those skilled in the art will appreciate from the present disclosure that various other features have not been illustrated for the sake of brevity and so as not to obscure more pertinent aspects of the implementations disclosed herein. To that end, the device 1000 includes memory 1001; one or more processors 1002 for executing modules, programs and/or instructions stored in the memory 1001 and thereby performing predefined operations; one or more network or other communications interfaces 1010; and one or more communication buses 1014 for interconnecting these components.

In some implementations, the device 1000 includes a user interface 1004 comprising a display device 1008 (e.g. a screen) and one or more input devices 1006 (e.g., touch screen or keyboard/mouse). When the device 1000 is a smart phone, the touch screen is both the display device 1008 and the input device 1006. The categories of the privacy-sensitive APIs and applications, as shown in FIGS. 3 and 5, as well as the warning messages, as shown in FIG. 7, are displayed on the display device 1008 and the user uses the input device 1006 to enter user inputs, allowing or rejecting the invocation of a privacy-sensitive API 1035 by an application 1034.

In some implementations, the memory 1001 includes high-speed random access memory, such as DRAM, SRAM, or other random access solid state memory devices. In some implementations, memory 1001 includes non-volatile memory, such as one or more magnetic disk storage devices, optical disk storage devices, flash memory devices, or other non-volatile solid state storage devices. In some implementations, memory 1001 includes one or more storage devices remotely located from the processor(s) 1002. Memory 1001, or alternately one or more storage devices (e.g., one or more nonvolatile storage devices) within memory 1001, includes a non-transitory computer readable storage medium.

In some implementations, memory 1001 or the computer readable storage medium of memory 1001 stores the following programs, modules and associated information items, or a subset thereof:
An operating system 1015 that includes procedures for handling various basic system services and for performing hardware dependent tasks.
An identification module 1016 used to identify a plurality of APIs as privacy-sensitive APIs (APIs) 1035 based on functions of the APIs and information items 1032 accessible to the APIs, wherein there is a prior user authorization 1030 for using the privacy-sensitive APIs 1035 by applications (APPs) 1034 running on the computing device 1000.
A categorization module 1018 used for storing correlations between the privacy-sensitive APIs 1035 and applications 1034 having prior user authorizations 1030 to access the privacy-sensitive APIs 1035 in a pre-set privacy-sensitive API access list 1036, categorizing the applications 1034 according to the privacy-sensitive APIs 1035, and/or categorizing the privacy-sensitive APIs 1035 according to the applications 1034.
A display module 1022 used for displaying the application categories according to the privacy-sensitive APIs 1035 in a privacy monitoring interface, receiving a user input for viewing the applications 1034 in an application category via the input device 1006, and searching the privacy-sensitive API access list 1036 and displaying the applications 1034 associated with the privacy-sensitive API 1035 as requested by the user input.
A condition setting module 1020 may be used for setting the predefined condition 1038 and/or confirming or overruling the prior authorization 1030.
A determination module 1024 used to determine whether the invoked API and the application satisfy a predefined condition 1038 in response to detecting an invocation 1037 of one of the privacy-sensitive API 1035 by an application 1034. The determination module 1024 may also be used for determining whether or not to allow the invocation 1037 of the API 1035 based on a reconfirmation or overruling 1039 of the prior authorization 1030 if the invoked API 1035 and the application 1034 do not satisfy the predefined condition 1038.
A processing module 1026 used to suspend the invocation 1037 of the API 1035 by the application 1034, display a message on a display 1008 of the computing device 1000, wherein the message indicates that the application 1034 attempts to invoke the privacy-sensitive API 1035, and determine whether or not to resume the invocation 1037 of the API 1035 based on a user response to the message, if the invoked API 1035 and the application 1034 satisfy the predefined condition 1038.
Various components stored in memory 1001, such as but not limited to the prior authorization 1030, applications (APPs) 1034, privacy-sensitive APIs (APIs) 1035, the privacy-sensitive API access list 1036, the predefined condition 1038, the detected invocation 1037, the reconfirmation/overruling 1039 of the prior authorization 1040, the decision 1040, and information items 1032 such as but not limited to personal pictures, messages, phone records, recordings; locations, chat histories, networking information, and system information of the computing device 1000.

As indicated above, with the prior user authorization 1030, the invocation of the privacy-sensitive API 1035 by an application 1034 may take place before or after the categorization is conducted.

In some implementations, the predefined condition 1038 is set to be automatically satisfied so that re-determination of invocation 1037 by user input through the user interface 1004 may not bypassed. Such a setup is optional and it is possible that predefined condition 1038 is only set up after the categorization and the establishment of the privacy-sensitive API access list 1036.

The corresponding relationship (or mapping) of the applications 1034 and the privacy-sensitive APIs 1035 are established by the identification module 1016. Searches of the privacy-sensitive API access list 1036 allow the identification of applications 1034 associated with a privacy-sensitive API 1035 and privacy-sensitive APIs 1035 associated with an application 1034. The categories of the applications 1034, the categories of the privacy-sensitive APIs 1035, and mapping relationship of the applications 1034 and the privacy-sensitive APIs 1035 may be displayed by the display 1008.

A user may view the categories and alter the predefined condition 1038, and/or reconfirming/overruling the prior authorization 1030, in order to make the decision 1040 as to whether the invocation 1037 may be successful.

The final decision 1040 is decided by the processing module 1026.

Those skilled in the art would understand that the whole or a part of the flow for realizing the method in the above-mentioned embodiments can be achieved by instructing relevant hardware by a computer program, wherein the program can be stored in a computer readable storage medium. When the program is being executed, the flow of the method of the above-mentioned various embodiments can be included therein. The storage medium can be a diskette, an optical disk, a read-only memory (ROM) or a random access memory (RAM), etc.

The above-mentioned embodiments only describe several implementation methods of the present invention. The description thereof is relatively specific and detailed, but it could not be understood as restrictions to the patent scope of the present invention. It should be noted that for those skilled in the art, several transformations and improvements can further be made without departing from the concept of the present invention, and these all belong to the scope of protection of the present invention. Therefore, the scope of protection of the present invention patent should be based on the appended claims.

The above descriptions are merely exemplary embodiments of the present invention, but not intended to limit the protection scope of the present invention. Any modification, equivalent replacement, or improvement made without departing from the spirit and principle of the present invention should fall within the protection scope of the present invention.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms “first,” “second,” etc., may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method for monitoring APIs in a computing device, comprising the steps of:
at the computing device having one or more processors and memory for storing one or more programs to be executed by the one or more processors,
identifying a plurality of APIs as privacy-sensitive APIs based on functions of the APIs and information items accessible to the APIs, wherein there is a prior user authorization for using the privacy-sensitive APIs by applications running on the computing device;
in response to detecting an invocation of one of the privacy-sensitive API by an application, determining whether the invoked API and the application satisfy a predefined condition:
if the invoked API and the application satisfy the predefined condition:
suspending the invocation of the API by the application;
displaying a message on a display of the computing device, wherein the message indicates that the application attempts to invoke the privacy-sensitive API; and
determining whether or not to resume the invocation of the API based on a user response to the message.

2. The method according to claim 1, further comprising:
determining whether or not to allow the invocation of the API to proceed based on a reconfirmation or overruling of the prior user authorization, if the invoked API and the application do not satisfy the predefined condition.

3. The method according to claim 1, wherein the prior user authorization is provided when an application is installed on the computing device.

4. The method according to claim 1, further comprising:
storing correlations between privacy-sensitive APIs and the applications having prior user authorization to access the privacy-sensitive APIs in a pre-set privacy-sensitive API access list;
categorizing the applications according to the privacy-sensitive APIs; and
categorizing the privacy-sensitive APIs according to the applications.

5. The method according to claim 4, further comprising:
displaying the application categories according to the privacy-sensitive APIs in a privacy monitoring interface;
receiving a user input for viewing the applications in an application category; and
searching the privacy-sensitive API access list and displaying the applications associated with the privacy-sensitive API as requested by the user input.

6. The method according to claim 5, further comprising:
setting the predefined condition for the associated application to invoke the privacy-sensitive API.

7. The method according to claim 6, wherein
the predefined condition is: requiring reconfirmation of the prior user authorization of allowing the application to invoke the privacy-sensitive API.

8. The method according to claim 6, wherein
the predefined condition is: the time between the current invocation and the last invocation of the privacy-sensitive API by the application is longer than a threshold period.

9. The method according to claim 4, further comprising:
displaying the privacy-sensitive API categories according to the applications in an application monitoring interface;
receiving a user input for viewing the privacy-sensitive APIs associated with an application; and
searching the privacy-sensitive API access list and displaying the privacy-sensitive APIs associated with the application.

10. The method according to claim 9, further comprising:
setting the predefined condition for the application to invoke the associated privacy-sensitive API.

11. The method according to claim 1, wherein:
the message displayed on the display of the computing device requests a user to choose to resume the invocation of the privacy-sensitive API.

12. The method according to claim 11, wherein the message sets a default of not resuming invocation of the privacy-sensitive API if the user does not enter a user response within a time limit.

13. The method of claim 12, wherein the time limit is 30 seconds

14. The method according to claim 11, wherein the message allows the user to revise the predefined condition.

15. The method according to claim 1, wherein the privacy-sensitive APIs are related to one or more of the followings: private conversation, recording, short messages, networking information, locations, and system information.

16. An API monitoring device, comprising:
one or more processors;
memory; and
one or more program modules stored in the memory and to be executed by the one or more processors, the one or more program modules including an identification module, a determination module, and a processing module, wherein
the identification module configured to identify a plurality of APIs as privacy-sensitive APIs based on functions of the APIs and information items accessible to the APIs, wherein there is a prior user authorization for using the privacy-sensitive APIs by applications running on the computing device;
the determination module configured to determine whether the invoked API and the application satisfy a predefined condition in response to detecting an invocation of one of the privacy-sensitive API by an application; and
and the processing module configured to:
suspend the invocation of the API by the application;
display a message on a display of the computing device, wherein the message indicates that the application attempts to invoke the privacy-sensitive API; and
determine whether or not to resume the invocation of the API based on a user response to the message, if the invoked API and the application satisfy the predefined condition.

17. The device of claim 16, wherein the processing module is further configured to:
determine whether or not to allow the invocation of the API based on a reconfirmation or overruling of the prior authorization if the invoked API and the application do not satisfy the predefined condition.

18. The device of claim 17, wherein the one or more program modules further comprise a categorization module, wherein:
the categorization module is configured to store correlations between privacy-sensitive APIs and applications having prior user authorizations to access the privacy-sensitive APIs in a pre-set privacy-sensitive API access list, categorize the applications according to the privacy-sensitive APIs, and categorize the privacy-sensitive APIs according to the applications;

19. The device of claim 17, wherein the one or more program modules further comprise a display module, wherein:
the display module is configured to display the application categories according to the privacy-sensitive APIs in a privacy monitoring interface, receive a user input for viewing the applications in an application category, and search the privacy-sensitive API access list and displaying the applications associated with the privacy-sensitive API as requested by the user input; and

20. The device of claim 17, wherein the one or more program modules further comprise a condition setting module, wherein:
the condition setting module is configured to set the predefined condition or confirming or overruling the prior authorization.
